(19) United States
(12) Patent Application Publication
(10) Pub. No.: US 2015/0375489 A1
(43) Pub. Date: Dec. 31, 2015

(54) FLEXIBLE CARPET CUSHION AND APPARATUS FOR MANUFACTURING THE SAME

(71) Applicant: SHAW INDUSTRIES GROUP, INC., DALTON, GA (US)

(72) Inventors: JOHN J.M. REES, Chattanooga, TN (US); TOM ODUM, Dalton, GA (US); IAN WHEELER, Kennesaw, GA (US)

(21) Appl. No.: 14/752,191

(22) Filed: Jun. 26, 2015

Related U.S. Application Data
(60) Provisional application No. 62/017,435, filed on Jun. 26, 2014.

(51) Int. Cl. B32B 37/10; B32B 37/06

(52) U.S. Cl. CPC B32B 37/10; B32B 37/06; B32B 2471/02; B32B 2305/72

(57) ABSTRACT

A system for continuously producing flexible carpet cushion having a mixing assembly positioned proximate to a slat press that is configured to dispense an uncured polyurethane (PU) foam onto a lower substrate associated with the moving lower plate of the slat press. As the uncured PU foam enters the slat press, an upper substrate associated with the upper plate of the slat press contacts the upper surface of the dispensed PU foam and the PU foam undergoes blowing to a gauged thickness and cures between the upper and lower plates of the slat press.

### BACKGROUND

1. Field of Use

According to various aspects, flexible carpet cushion and a continuous press for manufacturing the same are provided.

1. Related Art

Conventional carpet cushion can be produced on a tentered oven production line having tentering grippers to hold a woven or non-woven fabric having a sufficient width and linear strength. A polyurethane (PU) foam is typically deposited on the fabric via a traversing single pour dispenser and subsequently passes through a doctor blade to coarsely set the thickness of the uncured PU foam. Conventional reaction chemistry will then dictate if additional blowing occurs to achieve a reduction in density of the PU foam. On skilled in the art will appreciate that the PU foam requires a slow-reaction chemistry due to the use of a doctor blade and is typically mechanically frothed and chemically blown. A top film can be utilized to control the blowing by trapping the gasses and, additionally, to act as a barrier to prevent the PU foam from sticking to the rolls during production. Alternatively, the PU foam can be allowed to free rise, forming a skin on the top surface of the PU foam, which eliminates the top film and associated cost. An exemplary output of a conventional tentered oven is about 42 feet per minute of 12 foot wide carpet cushion. Exemplary carpet cushion produced on a conventional tentered line generally has a thickness of about 7/16 inches with a thickness accuracy of +/−15% and a density of about 8-10 PCF with an accuracy of +/−7.5% PCF. Typical waste of a tentered oven production line is about 8%.

In another aspect, conventional carpet cushion can be produced on a belted machine having both top and bottom chained belts. In this modality, films are placed on both the top and bottom chain to capture the uncured PU foam and prevent the foam from sticking to or flowing through the chain during production. Here, convective and radiant heat is utilized to cure the delayed reaction catalyst chemistry. Colorants and additives can also be utilized selectively to influence the pH and multiple reaction times, thus, the cure rate of the PU foam. One advantage of this method is the elimination of tentering, which allows for the use of a less expensive film versus the woven or non-woven fabrics required in tentering. Additionally, a bottom chain can be utilized alone, allowing the free rise of the PU foam during curing, which forms a skin of PU foam. Conventionally, a double chain-type of machine would generally have the lowest associated capital cost of 100% PU production equipment and the single chain-type is even cheaper. However, these chain-driven systems have considerable limits to their production speed of approximately 30-35 fpm. The double chain machine can produce a course gauged thickness PU cushion. However, chain sag can apply pressure to the PU foam cell structure and collapse some of the cells by creating some degree of “packing” or thickening of the top and bottom skin.

Conventional carpet cushion and the production thereof suffer from many limitations. Conventional carpet cushion is not a gauged product without subsequent processing and such subsequent processing creates waste. Additionally, conventional production methods require the use of a doctor blade or air knife to establish the base thickness of the cushion product. Use of a doctor blade requires restrictions on the reaction chemistry and use of a delayed reaction catalyst, all to ensure the PU foam is uncured when it passes under the blade. Without the proper reaction timing, cured PU can build up prior to passing the doctor blade, causing clogs, decreasing density uniformity and creating imperfections and holes in the top and bottom skin. Additionally, conventional carpet cushion is typically produced using convective heat which is less efficient than conductive heat.

In other aspects, laminating slat presses are typically used to produce rigid wall or roofing panels having a gauged thickness and width. Such slat presses are used in conjunction with chemically blown chemistry coupled with physical gas injection in a high pressure mixing system to produce rigid PU foam. Typically, rigid panels range from about 1″ to about 6″ in thickness and have a metallic film, paper or preformed metal cladding on each side of the panel, depending on the end use application. Accordingly, the fast-reaction mixing assembly is configured to dispense the uncured PU foam on the metallic film, paper or preformed metal cladding without a high degree of distribution accuracy. Thus, slat presses have heretofore only been used in conjunction with the production of relatively thick, rigid foam panels using fast-reaction chemistry and corresponding mixing and dispensing equipment.

Thus, what is needed is flexible carpet cushion and an apparatus for manufacturing the same that allows for a wider range of reaction chemistry, produces a gauged product without subsequent processing, minimizes energy costs by using a more efficient heat source to cure the final product, and has a more accurate dispensing means for the thinner thickness of the PU foam versus that of rigid chemical systems.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

One aspect of the present disclosure is to provide a system for continuous manufacture of a gauged PU foam. In one aspect, a slat press has a pair of opposed, spaced continuous conveyor belts that can be configured to move a portion of the respective belt at a desired speed along a machine direction of the slat press. Each conveyor belt has a plurality of selectably heated plates that are mounted to an exterior surface of the conveyor. In operation, as the plates of a top conveyor are positioned in opposition to the plates mounted on the bottom conveyor, it is contemplated that the respective plates of both the top conveyor and the bottom conveyor will be positioned in an adjoined relationship to form respective upper and lower plates that are selectably movable in the machine direction. The slat press can further comprise slat sides operable to control the dispensed PU foam expansion by restricting the flow to a preset width, reducing waste and controlling foam density. One skilled in the art will appreciate that the spaced, moving upper and lower plates, along with the slat sides, enable production of a PU foam having a gauged thickness and width. In another aspect, the slat press can be configured to conductively heat the PU foam through the moving upper and lower plates to facilitate curing while reducing energy costs relative to more conventional heating techniques (e.g., convective heating).

In another aspect of the present invention, a mixing assembly can be provided. The mixing assembly can comprise any one or combination of a high-pressure mix heads, low-pressure mix heads, mechanical frothers, and the like. In a further aspect, the mixing assembly can further comprise a dispensing assembly having a plurality of dispensing heads configured to provide precise side-to-side dispensing across the width of the application area.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the invention and together with the description, serve to explain various principles of the invention.

FIG. 1 is an exemplary schematic side elevation view the system of the present invention with the slat side being removed to beneficially show detail of the slat press.

FIG. 2 is an exemplary perspective view of uncured PU foam entering the moving mold of a slat press between an upper and a lower substrate.

FIG. 3 is an exemplary perspective view of uncured PU foam being delivered by Hennecke pour bars entering the moving mold of a slat press between an upper and a lower substrate.

FIG. 4 is a typical rigid PU formulation for PIR boardstock.

FIG. 5 is a typical rigid PU formulation for PUR sandwich panel.

FIG. 6 is one exemplary formulation of a flexible PU foam formulation.

FIG. 7 illustrates another exemplary chemical formulation of a PU foam produced according to the present disclosure.

### DETAILED DESCRIPTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein, while still obtaining the beneficial results described herein. It will also be apparent that some of the desired benefits described herein can be obtained by selecting some of the features described herein without utilizing other features. Accordingly, those who work in the art will recognize that many modifications and adaptations to the present invention are possible and can even be desirable in certain circumstances and are a part described herein. Thus, the following description is provided as illustrative of the principles described herein and not in limitation thereof.

Reference will be made to the drawings to describe various aspects of one or more implementations of the invention. It is to be understood that the drawings are diagrammatic and schematic representations of one or more implementations, and are not limiting of the present disclosure. Moreover, while various drawings are provided at a scale that is considered functional for one or more implementations, the drawings are not necessarily drawn to scale for all contemplated implementations. The drawings thus represent an exemplary scale, but no inference should be drawn from the drawings as to any required scale.

In the following description, numerous specific details are set forth in order to provide a thorough understanding described herein. It will be obvious, however, to one skilled in the art that the present disclosure may be practiced without these specific details. In other instances, well-known aspects of flooring manufacturing and urethane reaction chemistry have not been described in particular detail in order to avoid unnecessarily obscuring aspects of the disclosed implementations.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal aspect. “Such s” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be perdefined it is understood that each of these additional steps can be perdefined with any specific aspect or combination of aspects of the disclosed methods.

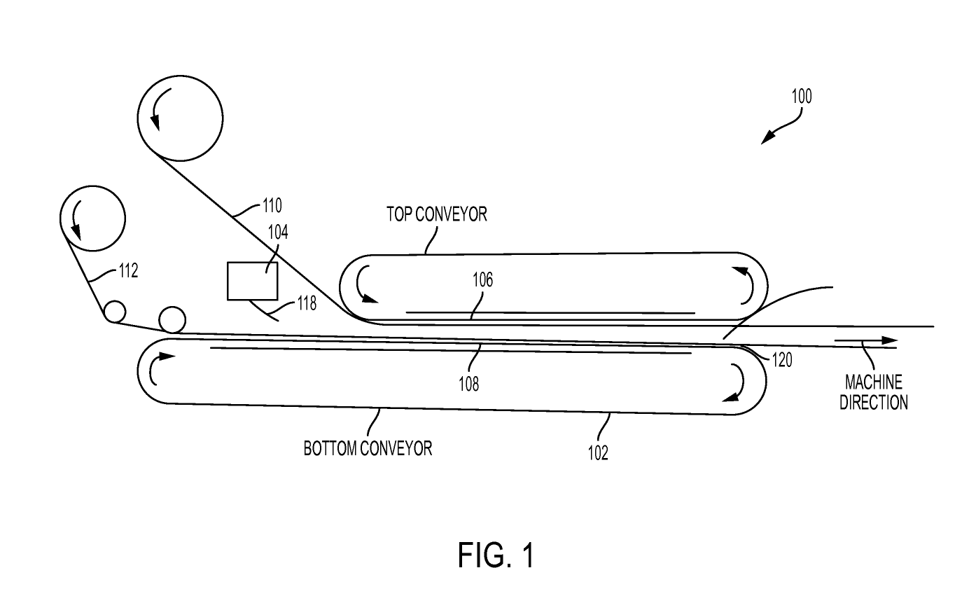

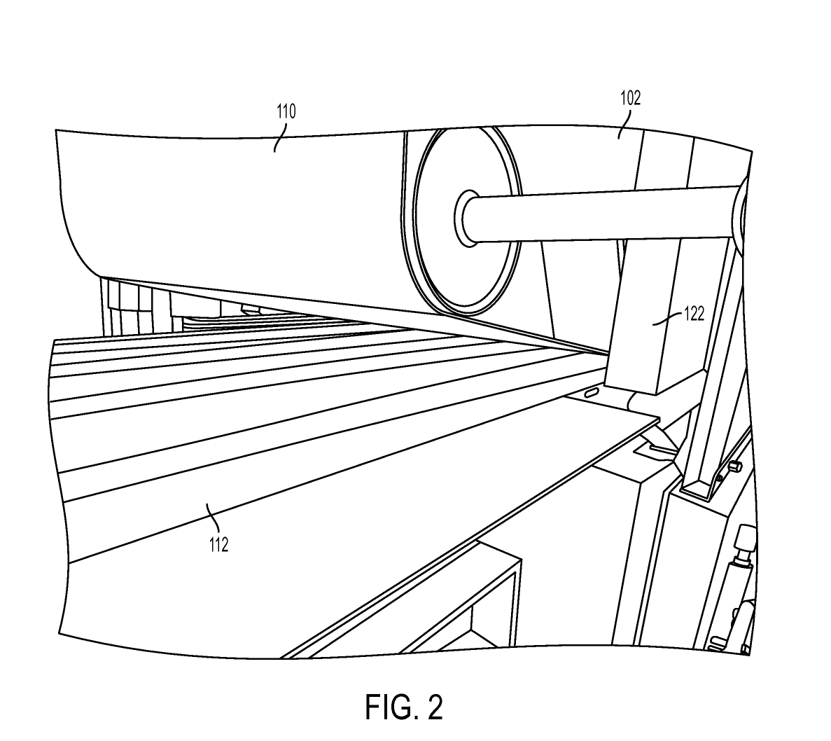

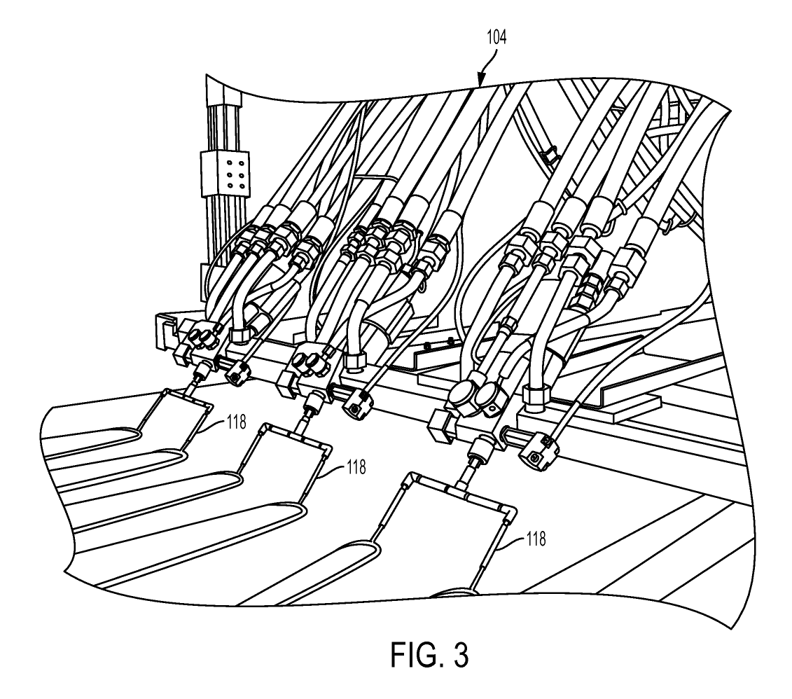

According to an exemplary aspect and as shown in FIGS. 1-3, a system 100 for producing flexible carpet cushion comprises a slat press 102 and a mixing assembly 104. In one aspect, the slat press has a pair of opposed, spaced continuous conveyor belts that can be configured to move a portion of the respective belt at a desired speed along a machine direction of the slat press. Each conveyor belt has a plurality of selectably heated plates that are mounted to an exterior surface of the conveyor. In operation, as the plates of a top conveyor are positioned in opposition to the plates mounted on the bottom conveyor, it is contemplated that the respective plates of both the top conveyor and the bottom conveyor will be positioned in an adjoined relationship to form respective upper and lower plates 106, 108 that are selectably movable in the machine direction through the slat press.

In a further aspect, the system 100 can also comprise an upper substrate 110 and associated means for feeding the upper substrate 110 under and in contact with the upper plate 106 at a location distal to the mixing assembly. The system 100 further comprises a lower substrate 112 and a means for feeding the lower substrate on top of and in contact with the lower plate 108 of the slat press at a location proximal to the mixing assembly. In yet another aspect, the mixing assembly can comprise a plurality of pour bars 118 and, in one exemplary aspect, one pour bar can be provided for each foot with of the lower substrate. In operation, the mixing assembly can selectively deliver an uncured PU foam mixture through the plurality of pour bars 118 onto the lower substrate.

One skilled in the art will appreciate that the moving plates forming the respective upper and lower plates 106, 108 form a continuous, fixed vertical gauge moving mold. The uncured PU foam mixture spreads to cover the width of the lower substrate and, as it passes into the moving mold of the slat press, contacts the upper substrate, which can also facilitate further distribution of the mixture. As the PU foam mixture moves through the slat press along the machine direction, the upper substrate 110 and lower substrate 112 are maintained in a fixed parallel relationship that restricts the foam blowing to a fixed gauge. One skilled in the art will appreciate that this fixed gauge enables direct production of a carpet cushion having a uniform thickness. It is contemplated that the system 100 can operate at speeds of up to 150 feet per minute and, in additional or alternative aspects, allow for use of fast-reaction PU formulations. In other aspects, the system can be adapted to accommodate both chemically blown and chemically blown/mechanically frothed PU foams. In one exemplary aspect, the slat press 102 can be, for example and without limitation, a Henneke JFLEX.

In one aspect, the slat press 102 can be gauged to a thickness of ⅞ inches and, in a further aspect, have a width of 6 feet. The resultant PU foam stock can be used at a ⅞-inch thickness or skived to produce 7/16-inch stock. It is contemplated that the system 100 can have a thickness accuracy of about 0.8%. In another aspect, can reduce wasted materials to about 2%, and, more preferably, about 1%. In an even further aspect, the system can produce a PU foam stock having a PCF density accuracy of about 1.9%.

Optionally, at least a portion of at least one of the upper and lower plates can define engraved imagery when the plates are positioned in the adjoined relationship. It is contemplated that the engraved imagery can comprise at least one pattern or design, such as, for example and without limitation, words, geometric patterns and shapes, organic and non-organic shapes, and the like. As one will appreciate, as the PU foam stock passes in the machine direction under the urging movement of the respective moving upper and lower plates, the engraved imagery would be embossed in the respective surface of the PU foam stock that underlies the engraved imagery on the respective plate.

Additionally, the slat press 102 can be configured to conductively heat the foam via the moving upper and lower plates, which enables reduced energy costs due to lower running temperatures relative to alternative heating methods. It is contemplated that the PU foam stock output from the slat press is at least about 75% cured and, more preferably, about 99% cured. In another aspect, it is contemplated that the cure values of the PU foam stock exiting the slat press can range between about 65% to about 99% cure. Optionally, the cure values of the PU foam stock exiting the slat press can range between about 75% to about 95% cure, with the cure values growing to between about 90% to about 99% cure in about 4 hours and between about 95% to about 100% cure in about 8 hours.

In one aspect, due to the time required for curing to a desired degree, the PU foam stock exiting the slat press can be output in the flat orientation to prevent undesired deformation of the PU foam stock as the final additional curing occurs. Optionally, in a further aspect, the PU foam stock exiting the slat press can be bent or otherwise maneuvered into a desired shape while the PU foam stock is in a green, not-fully cured condition.

In a further aspect, the slat press 102 can comprise slat sides 120, 122. In one aspect, the slat sides can restrict the amount of PU foam exiting the lateral edges of the moving mold, providing a gauged width and reducing waste. In another aspect, the slat sides can further enable the PU foam to build up a beneficial level of pressure during foaming and curing to improve the cell structure within the cured PU foam. In a further aspect, loss due to side trim for the slat press can be less than 5%, more preferably less than 3% and, most preferably, less than 1%. As one skilled in the art will appreciate in light of the present disclosure, producing flexible foam on a slat press can allow the PU foam to blow to a gauged thickness while using the minimal amount of PU foam volume to fill the fixed gauge moving mold formed by at least the top and bottom plates of the slat press without over packing the cell structure of the cured PU foam stock. Over packing occurs when excess foam flows to the restricted sides, increasing density and thickening the skin from collapsed foam cells. Additionally, too much over packing can damage the machine if the foam pressure is higher than the capacity of the machine. Generally, conventional slat presses uses relief valves, die springs, and the like to “give” in case of excessive foam pressure in order to prevent machine damage.

In a further aspect, the slat press 100 eliminates the need for a doctor blade or an air knife to establish the base thickness of the carpet cushion. Accordingly, the slat press eliminates the constraints on PU reaction time and corresponding reaction chemistry typically associated with use of a doctor blade. Additionally, the slat press eliminates the disadvantages of using an air knife such as the messy work area, protective garments for operators and plastic film sheeting or other barrier to contain the contamination.

In another aspect, in order to maximize production output with thinner PU foam stock, a slat press is constructed having a selected width. Traditional slat presses used in the production of rigid stock have a width of 4 feet. It is contemplated that the system of the present disclosure can have a width of at least 6 feet, at least 8 feet, or at least 10 feet.

In a further aspect, the mixing assembly 104 can comprise a high pressure mixer, a low pressure mixer, a mechanical frother and/or combinations thereof. In a further aspect, the mixing assembly 104 can be configured to accommodate from little to no filler using a high pressure mixing system up to high filler amounts using a low pressure mixing system. Here, “little to no filler” corresponds approximately to a cured PU foam density from about 2 to about 6 PCF and “high filler” corresponds approximately to cured PU foam density from about 7 to about 24 PCF.

In another aspect, multiple high-pressure heads can be located in close proximity to the point of application to accommodate faster reacting chemistry and to reduce the need for the PU foam to flow across the fabric or the lower substrate 112.

In one aspect, since the thickness of carpet cushion is considerably thinner in thickness than wall or roofing panels typically manufactured on a slat press, a dispensing end of the mixing assembly can be configured to have relatively high dispensing accuracy and precision with regards to the side-to-side dispensing volume as compared to conventional methods.

In one exemplary aspect, it is contemplated that the dispensing end of the mixing assembly can comprise a hub distribution system that has a central hub and a plurality of valves attached thereto. In this aspect, each valve of the plurality of valves produces an associated stream of PU foam in operation and the plurality of valves are distributed radially around a portion of the hub. The valves comprise holes that can be selectively sized to regulate and balance the foam output such that each valve outputs a substantially equal amount of foam. Additionally, as compared to rigid chemistry dispensing systems, the dispensing hub is configured to produce a greater number of streams, with each stream having a lower output, to ensure a uniform distribution of dispensed foam for the thinner PU foam substrate. In a further aspect, the system 100 can comprise a plurality of hub distribution systems to accommodate increased width products.

In another aspect, the mixing assembly 104 can be configured to achieve high-pressure impingement mixing. High-pressure impingement mixing typically uses high pressure pumps, operating at pressures of from about 1000 psi to about 3000 psi, to inject vis-à-vis liquid streams of premixed polyol and isocyanate. In operation, the vis-à-vis streams impact each other, intimately mixing to create a homogeneous PU foam. In further aspects, the mixing assembly 104 can comprise a Hennecke mix head, an OMS mix head, a Cannon mix head, and the like. As one skilled in the art will appreciate, improved mix quality results in improved foam quality. Also, proper, intimate, homogeneous mixing also reduces off-quality waste by enabling more uniform density and cell structure. In a further aspect, the high-pressure mix head can be configured to selectively introduce chemicals, additives, colorants and gasses into the PU foam mixture in addition to the polyol and isocyanate. It is contemplated that the flow rates of each of the components of the PU foam can be selectively controlled to ensure uniform application and reaction timing. In another aspect, the mixing assembly 104 can further comprise a static mixer. In yet another aspect, the mixing assembly 104 can comprise both a low and a high pressure mix head such as, for example and without limitation, a Hennecke type MD mix head, MT and ML mix heads; a Saip type D mix head such as a D18/12 and D24/18; an OMS mix head, a Cannon mix head, an Edge-Sweets mix head, a TPS mix head, a Meyer mix head, a PuMa head, and the like.

In another aspect, the mixing assembly 104 can be configured to achieve low-pressure mixing. It is further contemplated that the mixing assembly can comprise a system of low pressure pumps (less than 1000 psi) and dynamic mechanical blending at the mix head where polyol compound and isocyanate are mixed via mechanical action. In a further aspect, dynamic and/or static mixers could be used to achieve blending of the polyol and other chemicals before reaching the mix head. Alternatively, additional chemicals could be injected directly into the mix head. In another aspect, the mixing assembly 104 can be configured to achieve mechanical frothing. Here, the mixing assembly comprises frothing means employing a frothing gas such as, for example and without limitation, air, nitrogen, carbon dioxide and the like,

In another aspect, one exemplary generic PU foam formulation can comprise a polyether polyol blend, a polymeric MDI, a silicone surfactant, an amine catalyst, a metal catalyst, chemical blowing agents and physical blowing agents. The table below illustrates one exemplary formulation of a PU foam produced according to the present disclosure.

| Manufacturer | Component | Description | Parts | % of Total |
|---|---|---|---|---|
| Air Products | LK443 | Surfactant | 0.5 | 0.3 |
| Bayer | Arcol 11-34 | Polyol (4800 mw) | 85 | 48.7 |
| Bayer | PPG-2000 | Polyol (2000 mw) | 10.56 | 6.0 |
| Bayer | Mondur MR-5 | Isocyanate | 64.5 | 36.9 |
| Dabco | NE300 | Blow Catalyst | 0.05 | 0.0 |
| | | (skin) | | |
| Dabco | NE500 | Gel Catalyst | 0.15 | 0.1 |

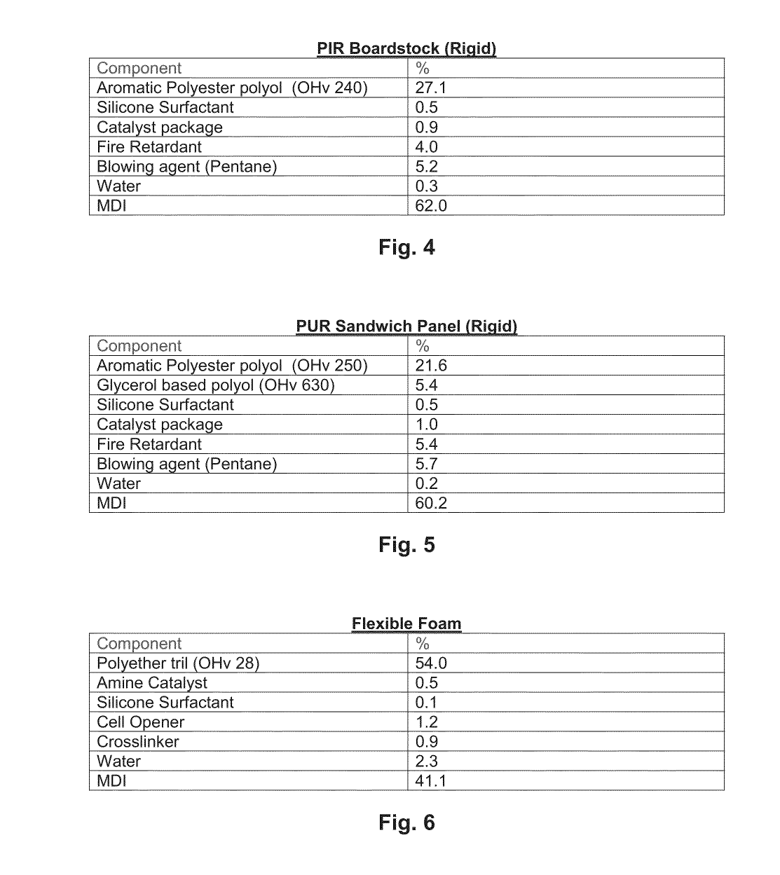

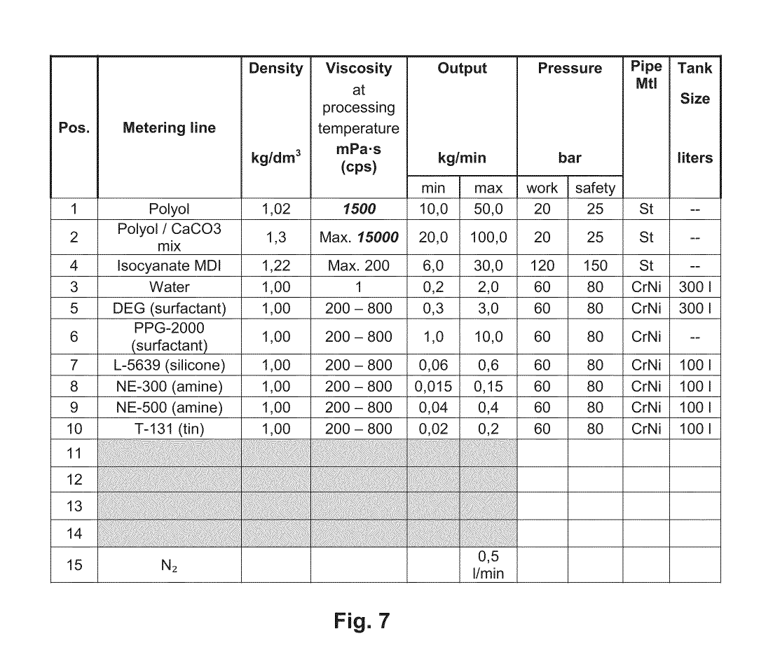

In another aspect, the flexible PU foam chemistry can be selectively customized with regard to all relevant reaction times which includes, for example and without limitation, cream time, rise time, gel time, tack-free time, and the like. These differences result in different polyols, isocyanates, catalysts, surfactants and blowing agents as compared to conventional rigid chemistry. FIGS. 4 and 5 illustrate respective rigid PU formulations for PIR boardstock and PUR sandwich panel while FIG. 6 illustrates one exemplary formulation of a flexible PU foam formulation. FIG. 7 illustrates yet another exemplary formulation of a flexible PU foam formulation.

In yet another aspect, the PU foam exiting the slat press can be cut or skived to create two pads. In yet another aspect, the PU foam exiting the slat press can be directly rolled and cut to length. In yet another aspect, a laminating station can be provided and the skived pads can undergo laminating to add, for example and without limitation, a second film, a scrim, a fabric or the like to the cut foam surface to add additional value or features to the pad.

In another aspect, release paper or release film can be used to shield the steel slat press plates from PU chemistry contamination, while allowing a breathable skin to form on the top and/or bottom surfaces of the pad. In one aspect, the release paper can be provided in lieu of a film and may or may not be reused subsequent to processing. It is contemplated to use release films or papers manufactured by, for example and without limitation, Sappi, Expera, Mid-South Extrusion and the like.

Accordingly, FIGS. 1-7, and the corresponding text, provide a number of different devices, systems, methods and mechanisms for continuously producing gauged PU foam. In addition to the foregoing, implementations described herein can also be described in terms of acts and steps in a method for accomplishing a particular result. For example, a method comprising providing and mixing PU foam constituents, dispensing the PU foam onto a lower substrate with good side-to-side distribution, contacting the upper surface of the PU foam with an upper substrate, providing a slat press having a series of continuously moving, mating upper and lower plates that cooperate to form a gauged mold, curing the PU foam in the slat press and outputting a cured, gauged PU foam is described concurrently above with reference to the components and diagrams of FIGS. 1-7.

The present invention can thus be embodied in other specific forms without departing from its spirit or essential characteristics. The described aspects are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An assembly for manufacturing a flexible carpet cushion comprising:
a mixing assembly having at least one mix head wherein the at least one mix head is operable to deliver a plurality of components that comprise a substantially homogeneous uncured polyurethane (PU) foam mixture; and
a laminating slat press comprising:
a pair of opposed, spaced continuous conveyor belts that are configured to move a portion of the respective conveyor belt at a desired speed along a machine direction of the slat press, wherein the pair of opposed, spaced continuous conveyor belts comprises a top conveyor and a bottom conveyor;
a plurality of selectably heated plates that are mounted to an exterior surface of the each continuous conveyor belt, wherein, as the plates of the top conveyor are positioned in opposition to the plates mounted on the bottom conveyor, it is contemplated that the respective plates of both the top conveyor and the bottom conveyor will be positioned in an adjoined relationship to form respective upper and lower plates that are selectably movable in the machine direction through the slat press, wherein the upper and lower plates are positioned parallel to the machine axis and are separated by a selected vertical gap, and wherein the upper plate and the lower plate are configured to move in a horizontal direction at substantially the same selected speed;
a means for feeding a lower substrate on top of and in contact with the lower plate at a location proximal to the mixing assembly; and
a means for feeding an upper substrate under and in contact with the upper plate at a location distal to the mixing assembly,
wherein the at least one mix head overlies and selectively applies the mixture to the lower substrate;
wherein the upper substrate contacts the mixture on the lower substrate to distribute the mixture over an area between the upper and lower plates; and
wherein the PU foam mixture cures at a preselected gauged thickness while bounded in the selected vertical gap between the upper and lower plate to form a cured PU foam stock.

2. The assembly of claim 1, wherein the substantially homogeneous uncured PU foam mixture comprises a polyol.

3. The assembly of claim 2, wherein the substantially homogeneous uncured PU foam mixture comprises an isocyanate.

4. The assembly of claim 3, wherein the substantially homogeneous uncured PU foam mixture comprises at least one catalyst.

5. The assembly of claim 4, wherein the at least one catalyst comprises a fast-reacting catalyst.

6. The assembly of claim 5, wherein the at least one catalyst comprises a delayed-reaction catalyst.

7. The assembly of claim 1, wherein the substantially homogeneous uncured PU foam mixture comprises at least a polyether polyol, a polymeric MDI, a silicone surfactant, at least one catalyst, and at least one blowing agent.

8. The assembly of claim 7, wherein the at least one catalyst comprises an amine catalyst.

9. The assembly of claim 7, wherein the at least one catalyst comprises a metal catalyst.

10. The assembly of claim 7, wherein the at least one blowing agent comprises a physical blowing agent and a chemical blowing agent.

11. The assembly of claim 1, wherein the mixing assembly further comprises a means for high pressure impingement mixing.

12. The assembly of claim 11, wherein the means for high pressure impingement mixing comprises a pump operating at pressures greater than about 1000 psi operable to deliver the first component and the second component through the at least one first mix head and the at least one second mix head.

13. The assembly of claim 1, wherein the mixing assembly further comprises a means for low pressure mixing.

14. The assembly of claim 1, wherein the mixing assembly further comprises a means for mechanical frothing.

15. The assembly of claim 1, wherein at least one of the lower substrate and the upper substrate is release paper.

16. The assembly of claim 1, wherein the mixing assembly comprises a first mixing assembly configured for low pressure mixing and the system further comprises a second mixing assembly configured for high pressure mixing and wherein the first mixing assembly and the second mixing assembly can be selectively interchanged.

17. The assembly of claim 1, wherein the pair of plates is further configured to conductively heat the mixture therebetween.

18. The assembly of claim 1, wherein the mixing assembly is movable along a machine direction relative to the laminating slat press.

19. A method for producing a flexible carpet cushion comprising:
providing an assembly for manufacturing a flexible carpet cushion comprising:
a mixing assembly having at least one mix head wherein the at least one mix head is operable to deliver a plurality of components that comprise a substantially homogeneous uncured polyurethane (PU) foam mixture; and
a laminating slat press comprising:
a pair of opposed, spaced continuous conveyor belts that are configured to move a portion of the respective conveyor belt at a desired speed along a machine direction of the slat press, wherein the pair of opposed, spaced continuous conveyor belts comprises a top conveyor and a bottom conveyor;
a plurality of selectably heated plates that are mounted to an exterior surface of the each continuous conveyor belt, wherein, as the plates of the top conveyor are positioned in opposition to the plates mounted on the bottom conveyor, it is contemplated that the respective plates of both the top conveyor and the bottom conveyor will be positioned in an adjoined relationship to form respective upper and lower plates that are selectably movable in the machine direction through the slat press, wherein the upper and lower plates are positioned parallel to the machine axis and are separated by a selected vertical gap, wherein portions of at least one of the upper and lower plates defines engraved imagery, and wherein the upper plate and the lower plate are configured to move in a horizontal direction at substantially the same selected speed;
a means for feeding a lower substrate on top of and in contact with the lower plate at a location proximal to the mixing assembly; and
a means for feeding an upper substrate under and in contact with the upper plate at a location distal to the mixing assembly,
wherein the at least one mix head overlies and selectively applies the mixture to the lower substrate;
wherein the upper substrate contacts the mixture on the lower substrate to distribute the mixture over an area between the upper and lower plates; and
providing a first component to the at least one mix head;
providing a second component to the at least one mix head;
causing the first and second components to mix to form a substantially homogeneous mixture;
applying the mixture to the lower substrate;
causing the upper substrate to contact and spread the mixture over the area between the upper and lower plates; and
causing the plates to conductively heat the mixture.
wherein the PU foam mixture cures at a preselected gauged thickness while bounded in the selected vertical gap between the upper and lower plate to form a cured PU foam stock, and wherein the engraved imagery is embossed in the surface of the cured PU foam stock.
